(19) United States
(12) Patent Application Publication
(10) Pub. No.: US 2012/0285713 A1
(43) Pub. Date: Nov. 15, 2012

(54) HAMMER CAGE FOR AN IMPACT TOOL

(76) Inventor: Jerry LIN, Tainan City (TW)

(21) Appl. No.: 13/460,491

(22) Filed: Apr. 30, 2012

(30) Foreign Application Priority Data
May 13, 2011 (TW) 100208640

(51) Int. Cl. B25D 17/00

(52) U.S. Cl. 173/93.5

(57) ABSTRACT

A hammer cage, adapted for use in an impact tool that has a pin and a hammer swingable on the pin, includes: first and second walls, and first and second connecting walls independently interconnecting the first and second walls and cooperating with the first and second walls to define an impact space for receiving the hammer; and a first restricting structure having a pin hole member that extends through the first wall and that is adapted for extension of the pin, and a first restricting protrusion that protrudes from the second connecting wall toward the first connecting wall and that is adapted for restricting swing motion of the hammer on the first pin in the impact space.

### CROSS-REFERENCE TO RELATED APPLICATION

This application claims priority of Taiwanese Application No. 100208640, filed on May 13, 2011.

### BACKGROUND OF THE INVENTION

1. Field of the Invention

The invention relates to a hammer cage for an impact tool, more particularly to a hammer cage that is driven by a rotor.

2. Description of the Related Art

As shown in FIG. 1, an impact unit 1 for a conventional twin-hammer impact tool can be driven to rotate by a rotor (not shown), and includes a hammer cage 11, first and second hammers 12, 12′, first and second pins 13, 13′, and a rotating shaft 14. The hammer cage 11 has a pair of wall segments 111, and a pair of connecting walls 112 independently interconnecting the wall segments 111 and cooperating with the wall segments 111 to define an impact space 113 for retaining the rotating shaft 14 and the first and second hammers 12, 12′. The hammer cage 11 has first and second pin-retaining structures 10, 10′ for retaining the first and second pins 13, 13′.

The first pin-retaining structure 10 consists of a pair of first through hole portions 101 formed respectively in the wall segments 111, and a first groove portion 102 formed in one of the connecting walls 112 and extending between the first through hole portions 101 such that the first pin 13 may be extended through the first through hole portions 101 and the first groove portion 102 to be retained in the impact space 113.

Similarly, the second pin-retaining structure 10′ consists of a pair of second through hole portions 101′ formed respectively in the wall segments 111, and a second groove portion 102′ formed in the other of the connecting walls 112 and extending between the second through hole portions 101′ such that the second pin 13′ may be extended through the second through hole portions 101′ and the second groove portion 102′ to be retained in the impact space 113.

Swing motion of each of the first and second hammers 12, 12′ on the first and second pins 13, 13′ is restricted by a respective one of the second and first pins 13′, 13. One of the wall segments 111 is formed with a shaft hole 114 and the other of the wall segments 111 is formed with a splined hole 115 such that the rotating shaft 14 may be extended through the shaft hole 114 and the impact space 113, and the hammer cage 11 may be operative coupled to the rotor at the splined hole 115. In such a configuration, the rotating shaft 14 may be driven rotatably by swing motion of the first and second hammers 12, 12′.

Referring to FIG. 2, a manufacturing process of the conventional hammer cage 11 generally includes four consecutive steps.

The first step includes forming (casting) a prime cage 19 having a pair of prime wall segments 191 and a pair of prime connecting walls 192 that independently interconnect the prime wall segments 191. The first step further includes forming a shaft hole 114 in one of the prime wall segments 191, and forming a prime engaging hole 193 in the other of the prime wall segments 191. Each of the prime connecting walls 192 has a sufficient thickness for forming of a respective one of the first and second pin-retaining structures 10, 10′.

The second step includes forming (drilling) each of two through holes 194 through the prime wall segments 191 and a corresponding one of the prime connecting walls 192.

The third step includes removing (cutting) a portion of each of the prime connecting walls 192 that is interposed between the impact space 113 and the corresponding through hole 194 to complete the formation of the corresponding first and second pin-retaining structure 10, 10′ such that the impact space 113 is in spatial communication with the first and second pin-retaining structure 10, 10′.

The fourth step includes forming the prime engaging hole 193 with a plurality of teeth on an inner surrounding surface of the prime engaging hole 193.

A hammer cage for a conventional single-hammer impact tool has a manufacturing process identical to that of the hammer cage for the twin-hammer impact tool.

Since casting, drilling, and cutting are involved, the manufacturing process is relatively costly and complex. Specifically, wearing and ageing of tools (e.g., drills) during the above manufacturing process may result in frequent replacement of the tools.

### SUMMARY OF THE INVENTION

Therefore, the object of the present invention is to provide a hammer cage that has a relatively simple manufacturing process.

Accordingly, a hammer cage of the present invention is adapted for use in an impact tool. The impact tool includes a first pin disposed in the hammer cage and extending in an extending direction, and a first hammer retained in the hammer cage and swingable on the first pin. The hammer cage comprises a first wall, a second wall spaced apart from the first wall in the extending direction, a first and a second connecting walls independently interconnecting the first and second walls and cooperating with the first and second walls to define an impact space in which the first hammer is retained, and a first restricting structure having a first pin hole member and a first restricting protrusion. The first pin hole member extends through a portion of the first wall proximate to the first connecting wall in the extending direction and is adapted for extension of the first pin therethrough. The first restricting protrusion protrudes from the second connecting wall toward the first connecting wall and is adapted for restricting swing motion of the first hammer on the first pin in the impact space.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional impact unit of a conventional twin-hammer impact tool;

FIG. 2 is a diagram showing a manufacturing process of a hammer cage of the conventional impact unit;

FIG. 3 is an exploded perspective view of an impact unit including a first preferred embodiment of a hammer cage according to the invention;

FIG. 4 is a diagram showing a manufacturing process of the hammer cage of the first preferred embodiment;

FIG. 5 is a sectional view of a second preferred embodiment of the hammer cage according to the invention;

FIG. 6 is a sectional view of a third preferred embodiment of a hammer cage of an impact unit according to the invention;

FIG. 7 is an exploded perspective view of the impact unit including a fourth preferred embodiment of the hammer cage according to the invention;

FIG. 8 is an assembled sectional view of the impact unit mounted with the fourth preferred embodiment; and

FIG. 9 is a diagram showing a manufacturing process of the fourth preferred embodiment.

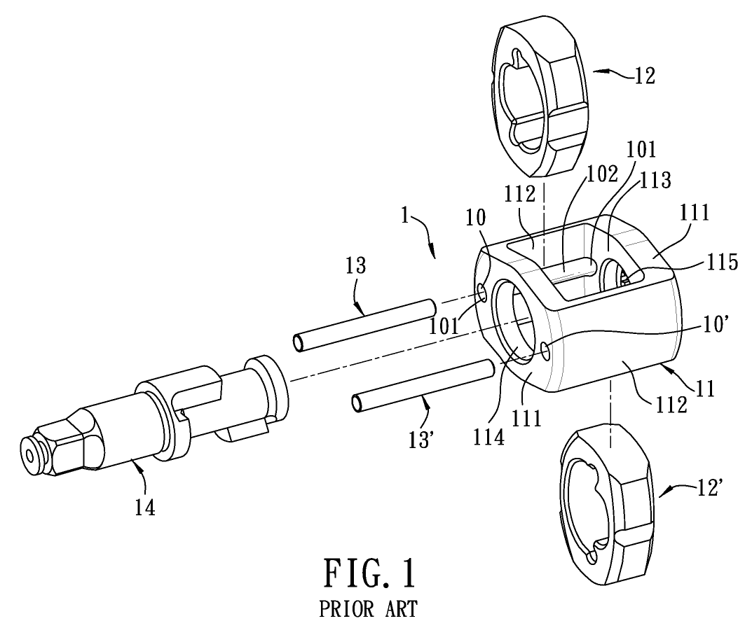

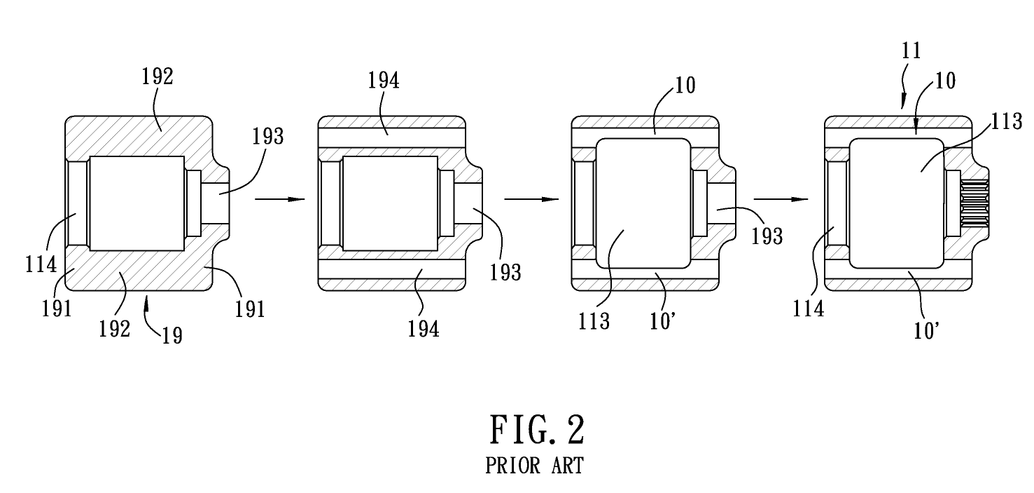

### DETAILED DESCRIPTION OF THE PREFERRED EMBODIMENTS

Before the present invention is described in greater detail, it should be noted that like elements are denoted by the same reference numerals throughout the disclosure.

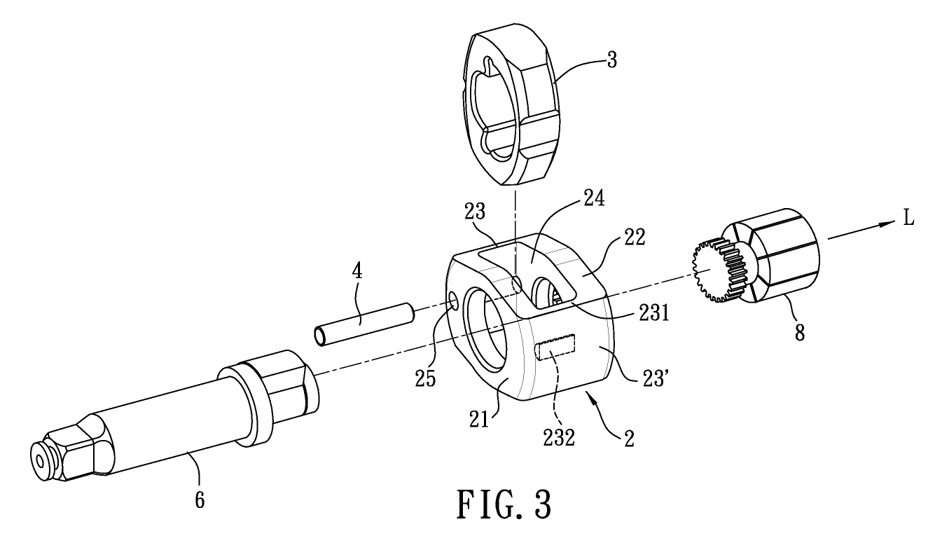

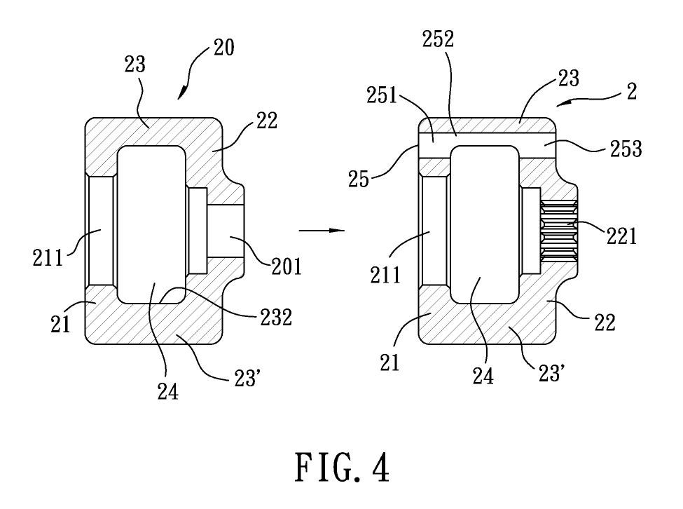

As shown in FIGS. 3 and 4, a first preferred embodiment of a hammer cage 2 according to the present invention is adapted for use in a single-hammer impact tool. The impact tool includes a first hammer 3, a first pin 4, and a rotating shaft 6. The first pin 4 is disposed in the hammer cage 2 and extends in an extending direction (L). The first hammer 3 is disposed in the hammer cage 2 and is swingable on the first pin 4. The rotating shaft 6 has a portion retained in the hammer cage 2 and is driven rotatably by the first hammer 3. The hammer cage 2 is driven to be rotatable by a rotor 8.

The hammer cage 2 in the first preferred embodiment comprises a first wall 21, a second wall 22 spaced apart from the first wall 21 in the extending direction (L), a first connecting wall 23 interconnecting the first and second walls 21, 22, a second connecting wall 23′ interconnecting the first and second walls 21, 22. The second connecting wall 23′ cooperates with the first and second walls 21, 22 and the first connecting wall 23 to define an impact space 24 in which the first hammer and the portion of the rotating shaft 6 are retained.

In this embodiment, the first wall 21 of the hammer cage 2 is formed with a shaft hole 211 adapted for extension of the rotating shaft 6 therethrough. The second wall 22 is formed with a splined hole 221 registered with the shaft hole 211 in the extending direction (L) and adapted to be operatively engaged with the rotor 8.

The hammer cage 2 further comprises a first restricting structure that has a first pin hole member 251, a first groove 252, a second pin hole member 253, and a first restricting protrusion 232. The first pin hole member 251 extends through a portion of the first wall 21 proximate to the first connecting wall 23 in the extending direction (L). The first groove 252 is formed in the first connecting wall 23, extends in the extending direction (L) and communicates spatially with the first pin hole member 251. The second pin hole member 253, in this embodiment, extends in the extending direction (L) through the second wall 22, communicates spatially with the first groove 252, such that the first pin 4 may be extended into and disposed in a first pin-retaining structure 25 cooperatively defined by the first pin hole member 251, the first groove 252, and the second pin hole member 253 for pivotally supporting the first hammer 3. It is noted that the second pin hole member 253 may be formed as a blind hole (i.e., the second pin hole member 253 may extend into a portion of the second wall 22). The first restricting protrusion 232 protrudes from the second connecting wall 23′ toward the first connecting wall 23, and is adapted for restricting swing motion of the first hammer 3 about the first pin 4.

During manufacturing of the first preferred embodiment, a prime cage 20 is first cast. The prime cage 20 has the first and second walls 21, 22, and the first and second connecting walls 23, 23′. The prime cage 20 is formed by casting such that the first wall 21 has the shaft hole 211, that the second connecting wall 23′ has the first restricting protrusion 232, and that the second wall 22 has a prime engaging hole 201. Then, the first pin-retaining structure 25 is formed by drilling from the first wall 21, through the first connecting wall 23, and to the second wall 22. Next, the splined hole 221 is formed by providing internal grooves in the prime engaging hole 201 to accomplish the manufacturing process.

Compared to the conventional hammer cage 11 illustrated in the prior art that is required to be formed with a pair of the pin-retaining structures 10 for respective insertion of a pair of pins 13, 13′ to respectively support and restrict swing motion of any of the hammers 12, 12′, only one pin-retaining structure 25 is employed in this invention, and restriction of swing movement of the first hammer 3 is cooperatively achieved by the first pin 4 and the first restricting protrusion 232 instead of by a pair of pins 13, 13′. Moreover, manufacturing of the hammer cage 2 of this embodiment does not include a cutting process. Therefore, manufacturing of the hammer cage 2 is a relatively simple and less costly.

It should noted that, the first groove 252 may be formed in the first connecting wall 23 early in the casting of the prime cage 20, so that the drilling process for the first restricting structure is only required to be performed on the first and the second walls 21, 22.

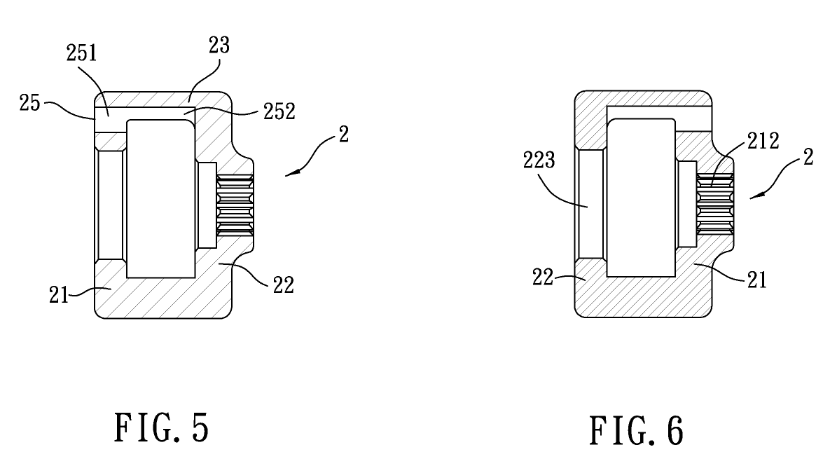

As shown in FIG. 5, a second preferred embodiment of the hammer cage 2 according to the present invention has a structure and a manufacturing process similar to those of the first preferred embodiment. The difference between the first and second preferred embodiments resides in that, in the second preferred embodiment, the second wall 22 is not drilled, so the first pin-retaining structure 25 of the second preferred embodiment includes only the first pin hole member 251 in the first wall 21 and the first groove 252 in the first connecting wall 23.

As shown in FIG. 6, a third preferred embodiment of the hammer cage 2 according to the present invention has a structure and a manufacturing process similar to those of the second preferred embodiment. The difference between the third and fourth embodiments resides in that, in the third preferred embodiment, the splined hole 212 is formed in the first wall 21 and the shaft hole 223 is formed in the second wall 22. The shaft hole 223 and the splined hole 212 are registered with each other in the extending direction (L).

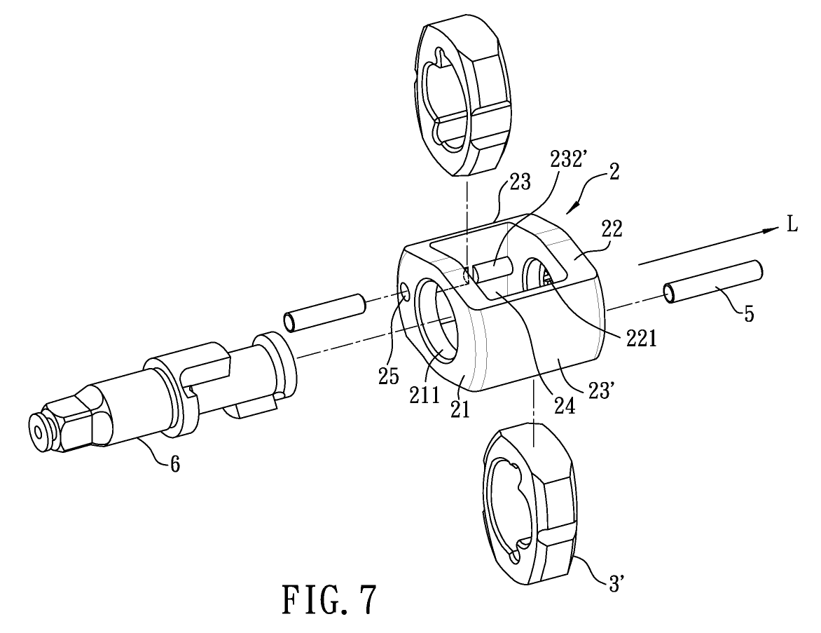

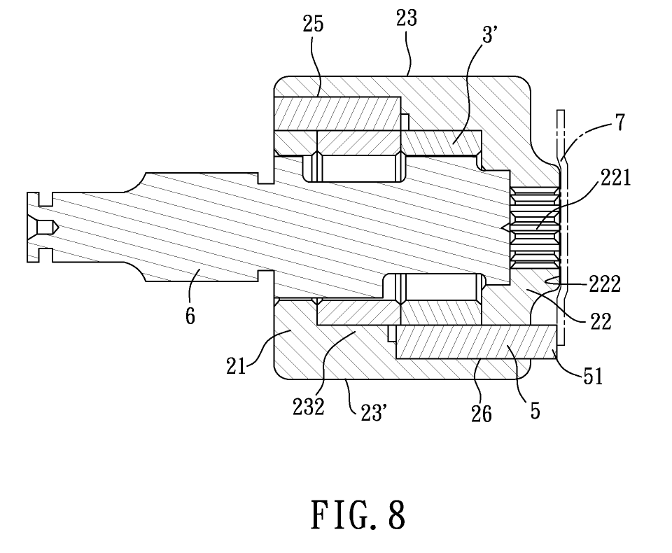

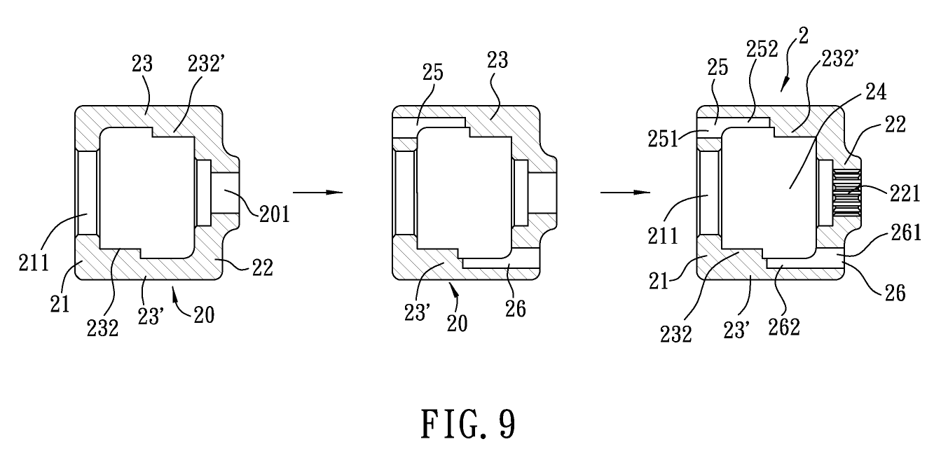

As shown in FIGS. 7, 8 and 9, a fourth preferred embodiment of the hammer cage 2 according to the present invention is adapted for use in a twin-hammer impact tool that, in comparison with above-mentioned single-hammer impact tool, further has, a second hammer 3′ and a second pin 5. The second pin 5 is disposed in the hammer cage 2, extends in an extending direction (L), is swingable on the second pin 5, and is adapted to drive rotation of the rotating shaft 6. In comparison with the above preferred embodiments, the hammer cage 2 of the fourth preferred embodiment has a greater length in the extending direction (L) for accommodating the second hammer 3′ and a second restricting structure corresponding to the second hammer 3′.

The first restricting structure, compared to the first preferred embodiment, only has the first pin hole member 251, the first groove 252 and the first restricting protrusion 232 (i.e., the second pin hole member 253 illustrated in the first preferred embodiment is omitted).

The second restricting structure has a second pin hole member 261 extending through a portion of the second wall 22 proximate to the second connecting wall 23′ in the extending direction (L), a second groove 262 formed in the second connecting wall 23′ extending in the extending direction (L) and communicating spatially with the second pin hole member 261. The second pin 5 may be extended into and disposed in a second pin-retaining structure 26 cooperatively defined by the second pin hole member 261 and the second groove 262 for pivotally supporting the second hammer 3′. The second restricting structure further has a second restricting protrusion 232′ protruding from the first connecting wall 23 toward the second connecting wall 23′ and adapted for restricting swing motion of the second hammer 3′.

Preferably, each of the first and the second grooves 252, 262, has a length substantially equal to a half of a length of an impact space 24 of this embodiment in the extending direction (L). Also, the first and the second restricting protrusions 232, 232′ have lengths substantially equal to a half of the length of the impact space 24 in the extending direction (L), and are disposed adjacent to the second and the first wall 22, 21, respectively.

Preferably, the second pin 5 has a length larger than an overall length of the second pin-retaining structure 26 of the second restricting structure. That is, the second pin 5 has an extending portion 51 extending outwardly from the second pin-retaining structure 26, and flush with an end surface 222 of the second wall 22 such that the extending portion 51 abuts against a gasket unit 7 of the twin-hammer impact tool.

During manufacturing of the hammer cage 2 of the fourth preferred embodiment, a prime cage 20 is first cast. The prime cage 20 has the first and second walls 21, 22, and first and second connecting walls 23, 23′. The prime cage 20 is formed by casting such that the first wall 21 has the shaft hole 211, that the second wall 22 has the prime engaging hole 201, that the second connecting wall 23′ has the first restricting protrusion 232, and that the first connecting wall 23 has the second restricting protrusion 232′. Then, the first pin-retaining structure 25 is formed by drilling from the first wall 21 into the first connecting wall 23, and the second pin-retaining structure 26 is formed by drilling from the second wall 22 into the second connecting wall 23′. Finally, the splined hole 221 is formed by providing internal grooves in the prime engaging hole 201 to accomplish the manufacturing process.

Compared to the conventional impact unit illustrated in the prior art, the presence of the first and second restricting protrusions 232, 232′ simplifies the drilling process on the first and second connecting walls 23, 23′ of the hammer cage 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A hammer cage adapted for use in an impact tool, the impact tool including a first pin that is disposed in said hammer cage and that extends in an extending direction, and a first hammer that is retained in said hammer cage and that is swingable on the first pin, said hammer cage comprising:
a first wall;
a second wall that is spaced apart from said first wall in the extending direction;
a first connecting wall that interconnects said first and second walls;
a second connecting wall that interconnects said first and second walls, and that cooperates with said first and second walls and said first connecting wall to define an impact space in which the first hammer is retained; and
a first restricting structure that has
a first pin hole member extending through a portion of said first wall proximate to said first connecting wall in the extending direction and adapted for extension of the first pin therethrough, and
a first restricting protrusion protruding from said second connecting wall toward said first connecting wall, and adapted for restricting swing motion of the first hammer on the first pin in said impact space.

2. The hammer cage as claimed in claim 1, wherein said first restricting structure further has a first groove formed in said first connecting wall, extending in the extending direction and communicating spatially with said first pin hole member for retaining a portion of the first pin.

3. The hammer cage as claimed in claim 2, wherein said first restricting structure further has a second pin hole member extending into a portion of said second wall proximate to said first connecting wall in the extending direction, and communicating spatially with said first groove.

4. The hammer cage as claimed in claim 2, the impact tool further including a rotating shaft having a portion that is retained in said hammer cage and driven rotatably by the first hammer, and a rotor for rotatably driving said hammer cage, wherein:
one of said first and second walls is formed with a shaft hole adapted for extension of the rotating shaft; and
the other one of said first and second walls is formed with a splined hole registered with said shaft hole in the extending direction and adapted to be operatively engaged with the rotor.

5. The hammer cage as claimed in claim 1, the impact tool further including a second pin that is disposed in said hammer cage and that extends in the extending direction, and a second hammer that is retained in said impact space of said hammer cage and that is swingable on the second pin, said hammer cage further comprising:
a second restricting structure that has
a second pin hole member extending through a portion of said second wall proximate to said second connecting wall in the extending direction and adapted for extension of the second pin therethrough, and
a second restricting protrusion protruding from said first connecting wall toward said second connecting wall, and adapted for restricting swing motion of the second hammer on the second pin in said impact space.

6. The hammer cage as claimed in claim 5, wherein:
said first restricting member further has a first groove formed in said first connecting wall, extending in the extending direction and communicating spatially with said first pin hole member of said first restricting structure for retaining a portion of the first pin; and
said second restricting structure further has a second groove formed in said second connecting wall, extending in the extending direction and communicating spatially with said second pin hole member of said second restricting structure for retaining a portion of the second pin.

7. The hammer cage as claimed in claim 6, the impact tool further including a rotating shaft retained in said hammer cage and driven rotatably by the first and second hammers and a rotor for rotatably driving said hammer cage, wherein:
said first wall of said hammer cage is formed with a shaft hole adapted for extension of the rotating shaft; and
said second wall of said hammer cage is formed with a splined hole registered with said shaft hole in the extending direction and adapted to be operatively engaged with the rotor.

8. The hammer cage as claimed in claim 7, wherein said second pin hole member and said second groove of said second restricting structure has an overall length smaller than that of the second pin in the extending direction.
